(19) United States
(12) Patent Application Publication
(10) Pub. No.: US 2015/0273998 A1
(43) Pub. Date: Oct. 1, 2015

(54) HYBRID VEHICLE

(71) Applicants: Hiroaki KIYOKAMI, Aichi (JP); Norihiro YAMAMURA, Aichi (JP)

(72) Inventors: Hiroaki Kiyokami, Miyoshi-shi Aichi-ken (JP); Norihiro Yamamura, Nisshin-shi Aichi-ken (JP)

(21) Appl. No.: 14/441,021

(22) PCT Filed: Dec. 12, 2012
(86) PCT No.: PCT/JP2012/082247

§ 371 Date: May 6, 2015

(51) Int. Cl. B60K 6/365; B60K 6/445; B60K 6/40

(52) U.S. Cl. CPC B60K 6/365; B60K 6/40; B60K 6/445; Y10S 903/91

(57) ABSTRACT

A planetary carrier Cf for a power division mechanism 3, which is provided in a power transmission system of a hybrid vehicle and linked to an input shaft 21 of an engine 1, includes stepped pinion gears each including a main pinion gear section Pf1 and a subpinion gear section Pf2. The main pinion gear sections Pf1 mesh with a sun gear Sf and a ring gear Rf of the power division mechanism 3. The subpinion gear sections Pf2 mesh with a ring gear R2 coupled to a drive shaft 91 of an oil pump 9. The oil pump 9 is thereby driven not only in HV travel and P charging during which the engine 1 is running, but also in EV travel.

### TECHNICAL FIELD

The present invention relates in general to hybrid vehicles with an internal combustion engine and an electric motor as travel driving force sources and also with a planetary gear mechanism included in a power transmission system and in particular to modification of a power transmission path for driving an oil pump.

### BACKGROUND ART

Patent Documents 1 and 2 disclose examples of conventional hybrid vehicles, which are provided with an engine (internal combustion engine) and an electric motor so as to travel using either one of the engine and the electric motor as a travel driving force source or both as travel driving force sources. The electric motor runs on the electric power generated by the output of the engine or stored in a battery (electric storage device).

In the power transmission system for a hybrid vehicle disclosed in Patent Documents 1 and 2, the output shaft of the engine is coupled to a planetary carrier of a power division mechanism containing a planetary gear mechanism, a first electric motor is coupled to a sun gear, and a second electric motor is coupled to a ring gear, for example, via a reduction mechanism. Drive wheels are coupled to this ring gear, for example via a differential device, for power transmission.

Hence, the torque that is supplied from the engine to the planetary carrier and divided for the ring gear (directly transmitted torque) drives the drive wheels in normal driving. Meanwhile, the torque divided for the sun gear is transmitted to the first electric motor, which in turn generates electric power. The electric power thus obtained drives the second electric motor to produce assist torque for the drive wheels.

When the engine operates in a region where its efficiency is low, such as when the vehicle is accelerating from standstill or when the vehicle is traveling at low speed, the engine is stopped and the drive wheels are driven only by the power of the second electric motor.

### CITATION LIST

### Patent Literature

Patent Document 1: Japanese Patent Application Publication, Tokukai, No. 2011-219011

Patent Document 2: Japanese Patent Application Publication, Tokukai, No. 2011-230713

Patent Document 3: Japanese Patent Application Publication, Tokukaihei, No. 10-67238

### SUMMARY OF THE INVENTION

### Problems to be Solved by the Invention

In this kind of hybrid vehicle, the oil pump is directly coupled to the output shaft of the engine so that the oil pump can be driven by the engine power as disclosed in Patent Documents 1 and 2. The oil pump hence ejects engine oil, which lubricates and cools down various parts inside the engine and the hybrid system. For example, the engine oil is supplied to the power division mechanism to lubricate the gears therein and to a motor generator cooling pipe to cool down the electric motor (motor generator).

Therefore, when the drive wheels are driven only by the power of the second electric motor (hereinafter, may be referred to as “in EV travel”), the oil pump is stopped because the engine is not running. Consequently, the parts are not lubricated or cooled. This absence of lubrication and cooling may lead to serious results, especially, with plug-in hybrid vehicles which tend to have extended EV travel periods (which continue EV travel until the remaining charge of the battery reaches a predetermined level).

A viable solution would be to use an electric oil pump so that engine oil can be supplied regardless of the engine driving state. This is however not always a preferred option because setting aside a space to accommodate the electric oil pump would be difficult, limit vehicle design, and increase cost.

Patent Document 3 may offer a partial solution to these problems. According to Patent Document 3, the input shaft of the oil pump supports a first and a second driven gear via respective one-way clutches. The first driven gear is meshed with a first drive gear that is fixed to a travel rotation shaft, whereas the second driven gear is meshed with a second drive gear that is fixed to an engine input shaft. The one-way clutch for one of the first and second driven gears that is rotating at higher rotational speed than the other one is locked so that power can be transmitted to the input shaft of the oil pump. In EV travel, this arrangement enables the one-way clutch for the first drive gear to be locked so that the oil pump can be driven.

However, the arrangement proposed in Patent Document 3 contains two paths for power transmission to the input shaft of the oil pump (two power transmission systems) each of which requires a one-way clutch. The arrangement therefore impractically adds to the overall physical dimensions of the power transmission systems.

In view of these problems, it is an object of the present invention to provide a hybrid vehicle having a power transmission system capable of driving an oil pump even in EV travel without adding to the physical dimensions of the power transmission system.

### Solution to Problem

### Solution Principles of the Invention

The solution offered by the present invention to achieve the object works based on the following principles. The rotational force of pinion gears supported by the planetary carrier of a planetary gear mechanism in a power transmission system for a hybrid vehicle is transmitted to an oil pump so that the oil pump is driven by rotation of the pinion gears. In other words, when the internal combustion engine is running, the internal combustion engine transmits its power to the oil pump via the pinion gears as the planetary carrier coupled to the internal combustion engine rotates; when the internal combustion engine is being stopped while the vehicle is traveling (when the drive wheels are rotating), the drive wheels transmit their power to the oil pump via the pinion gears as a ring gear coupled to the drive wheels rotates.

### Means to Solve Problem

Specifically, the present invention is conditioned to for application to a hybrid vehicle provided with a power transmission system including a planetary gear mechanism containing: a planetary carrier coupled to an output shaft of an internal combustion engine; a sun gear coupled to an electric motor; and a ring gear coupled to a drive wheel. The hybrid vehicle is arranged so that pinion gears that are supported by the planetary carrier of the planetary gear mechanism in a freely rotatable manner are coupled to a drive shaft of an oil pump to enable power transmission.

According to these specific features, first, when the internal combustion engine is running while the vehicle is traveling, the internal combustion engine transmits its power to the drive wheel via the planetary carrier and the ring gear so that the vehicle can travel. In this situation, since the planetary carrier is rotated by the power transmitted from the internal combustion engine, the pinion gears supported by the planetary carrier either orbit simply or orbit while self-rotating. The rotational force of the pinion gears is then transmitted to the drive shaft of the oil pump, thereby driving the oil pump. Meanwhile, when the internal combustion engine is being stopped while the vehicle is traveling, the planetary carrier does not rotate because the internal combustion engine is not running. The drive wheel is however rotating, and its rotational force rotates the ring gear of the planetary gear mechanism. The rotational force of the ring gear is transmitted to the pinion gears, causing the pinion gears to self-rotate. The rotational force of the pinion gears is in turn transmitted to the drive shaft of the oil pump, thereby driving the oil pump. As detailed so far, according to the means to solve problem of the present invention, the oil pump is driven both when the internal combustion engine is running while the vehicle is traveling and when the internal combustion engine is being stopped while the vehicle is traveling. That enables oil to be delivered to various members that need lubrication or cooling in both cases. As could be understood from the description so far, the means to solve problem of the present invention does not need the conventional arrangement that includes two power transmission paths leading to the drive shaft of the oil pump and two one-way clutches provided respectively for the power transmission paths. Hence, the present invention realizes a power transmission system capable of driving an oil pump both when the internal combustion engine is running while the vehicle is traveling and when the internal combustion engine is being stopped while the vehicle is traveling, without adding to the physical dimensions of the power transmission system.

In an example of a more specific arrangement, the pinion gears may include stepped pinion gears each including a main pinion gear section and a subpinion gear section that are formed so as to rotate integrally; the main pinion gear sections may be meshed with the sun gear and the ring gear of the planetary gear mechanism; and the subpinion gear sections may be meshed with a pump-driving ring gear coupled to the drive shaft of the oil pump.

Especially, the subpinion gear sections may have a smaller diameter than the main pinion gear sections.

This particular structure of the pinion gears being composed of stepped pinion gears enables the rotational speed of the drive shaft of the oil pump to differ from the self-rotation speed of the pinion gears. In other words, the rotational speed of the drive shaft of the oil pump can be rendered higher or lower than the rotational speed of the pinion gears. The structure thus enables the oil pump to be driven at high efficiency if the outer diameter (number of teeth) of the subpinion gear sections is specified appropriately relative to that of the main pinion gear sections. Especially, when the subpinion gear sections have a smaller diameter than the main pinion gear sections as mentioned above, the subpinion gear sections and the pump-driving ring gear that meshes with the subpinion gear sections can be accommodated in a reduced space. That facilitates installation of the subpinion gear sections and the pump-driving ring gear in the engine compartment.

Examples of the suitable locations of the subpinion gear sections include the following. Firstly, the subpinion gear sections may be located on the same side of the main pinion gear sections as is the internal combustion engine. Secondly, the subpinion gear sections may be located on the opposite side of the main pinion gear sections from the internal combustion engine.

Especially, when the subpinion gear sections are located on the opposite side of the main pinion gear sections from the internal combustion engine, the oil pump will unlikely receive thermal damage, for example, under heat radiation from the internal combustion engine, which may allow for extended life for the oil pump.

As a concrete example of the traveling state of the vehicle with the internal combustion engine being stopped, there may be provided a second electric motor capable of power transmission to and from the ring gear of the planetary gear mechanism via a gear train, and the second electric motor may transmit power thereof to the drive wheel via the gear train while the vehicle is traveling with the internal combustion engine being stopped and the planetary carrier not rotating.

In other words, the second electric motor may transmit its power to the ring gear of the planetary gear mechanism via a gear train. That power rotates (causes self-rotation of) the pinion gears, driving the oil pump.

### Advantageous Effects of the Invention

According to the present invention, the rotational force of pinion gears supported by the planetary carrier of a planetary gear mechanism in a power transmission system for a hybrid vehicle is transmitted to an oil pump so that the oil pump is driven by rotation of the pinion gears. Hence, the oil pump can be driven when the internal combustion engine is running while the vehicle is traveling and when the internal combustion engine is being stopped while the vehicle is traveling, without adding to the physical dimensions of the power transmission system.

### BRIEF DESCRIPTION OF DRAWINGS

FIG. 1 is a schematic diagram representing a hybrid vehicle in accordance with an embodiment.

FIG. 2 is a block diagram of a control system including an ECU.

FIG. 3 is a diagram representing an exemplary driving force source map.

FIG. 4 is a collinearity graph representing the rotational speeds of various rotational elements of a power division mechanism in HV travel.

FIG. 5 is a collinearity graph representing the rotational speeds of various rotational elements of a power division mechanism in EV travel.

FIG. 6 is a schematic diagram of a power transmission system for a hybrid vehicle in accordance with a comparative example.

FIG. 7 is a collinearity graph representing the rotational speeds of various rotational elements of a power division mechanism in EV travel for a hybrid vehicle in accordance with a comparative example.

FIG. 8 is a schematic diagram of a power transmission system for a hybrid vehicle in accordance with a first variation example.

FIG. 9 is a schematic diagram of a power transmission system for a hybrid vehicle in accordance with a second variation example.

FIG. 10 is a collinearity graph representing the rotational speeds of various rotational elements of a power division mechanism and a reduction mechanism in EV travel for a hybrid vehicle in accordance with the second variation example.

FIG. 11 is a schematic diagram of a power transmission system for a hybrid vehicle in accordance with a third variation example.

FIG. 12 is a schematic diagram of a power transmission system for a hybrid vehicle in accordance with a fourth variation example.

### DESCRIPTION OF EMBODIMENTS

The following will describe embodiments of the present invention in reference to drawings. The immediately following embodiment (“the present embodiment”) will discuss the present invention applied to an FF (front engine, front wheel drive) hybrid vehicle.

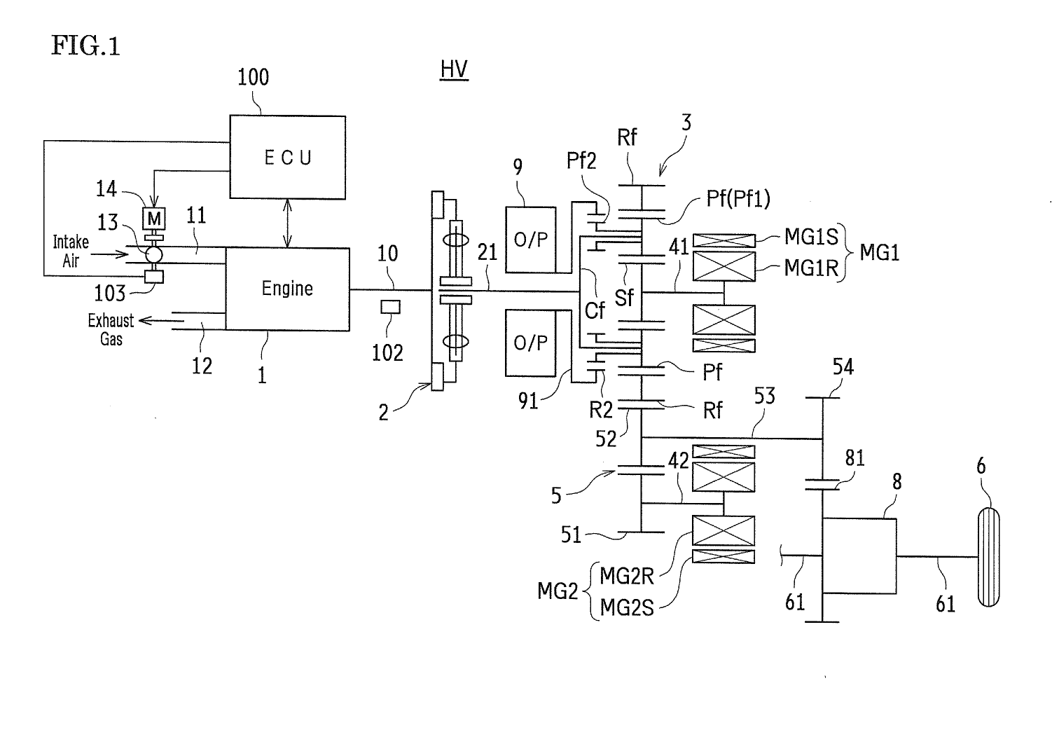

FIG. 1 is a schematic diagram representing a hybrid vehicle HV in accordance with the present embodiment. As illustrated in FIG. 1, the hybrid vehicle HV includes, for example, an engine (internal combustion engine) 1 generating vehicle travel driving force, a first motor generator (first electric motor) MG1 serving primarily as an electric power generator, a second motor generator (second electric motor) MG2 serving primarily as an electric motor, a power division mechanism 3, a gear train 5 transmitting the torque output of the power division mechanism 3 and the torque output of the second motor generator MG2 to a differential device 8, front wheel axles (drive shafts) 61, front wheels (drive wheels) 6, and an ECU (electronic control unit) 100.

The ECU 100 is composed of, for example, a HV (hybrid) ECU, an engine ECU, and a battery ECU that are mutually connected in such a manner as to enable communications between them.

The power transmission system of a hybrid vehicle HV in accordance with the present embodiment is a double-axis gear train in which the rotation shaft axis of the engine 1 and that of the first motor generator MG1 are positioned on a common axial line whereas the rotation shaft axis of the second motor generator MG2 is positioned on another axial line (an axial line that is offset from these rotation shaft axes). This structure reduces the length of the entire transaxle in its axial line direction (i.e., the total length of the transaxle in the vehicle's width direction) and increases layout freedom for each shaft, which in turn contributes to improved ease in installation.

Now, the engine 1, the motor generators MG1 and MG2, the power division mechanism 3, the gear train 5, and the ECU 100 among others will be individually described.

### Engine

The engine 1 is a publicly known power unit that combusts fuel for power output, such as a gasoline engine or a diesel engine. The engine 1 has a structure that allows for control over its operating conditions, such as the opening degree of the throttle valve 13 disposed on an intake air path 11, the fuel injection amount, and the ignition period. The exhaust gas produced by combustion is passed through an exhaust gas path 12, purified, for example, by an oxidative catalyst (not shown) in an exhaust gas purification device, and thereafter discharged into air.

The throttle valve 13 of the engine 1 is controlled by using, for example, well-known electronic throttle control technology by which the throttle opening degree is controlled in such a manner as to achieve an optimal intake air amount (target intake air amount) that is suited to the conditions of the engine 1 including the rotational speed of the engine 1 and the amount of depression of the accelerator pedal (accelerator opening degree) effected by the driver.

The output of the engine 1 is transmitted to an input shaft 21 via a crankshaft (output shaft) 10 and a damper 2. The damper 2 is, for example, a coil spring-based transaxle damper that absorbs torque variations of the engine 1.

### Motor Generators

The first motor generator MG1 is an AC synchronous power generator provided with a rotor MG1R which is built around a permanent magnet and a stator MG1S around which three-phase wires are wound. The first motor generator MG1 serves primarily as an electric power generator and additionally as an electric motor. The second motor generator MG2 is also an AC synchronous power generator similarly provided with a rotor MG2R which is built around a permanent magnet and a stator MG2S around which three-phase wires are wound. The second motor generator MG2 serves primarily as an electric motor and additionally as an electric power generator.

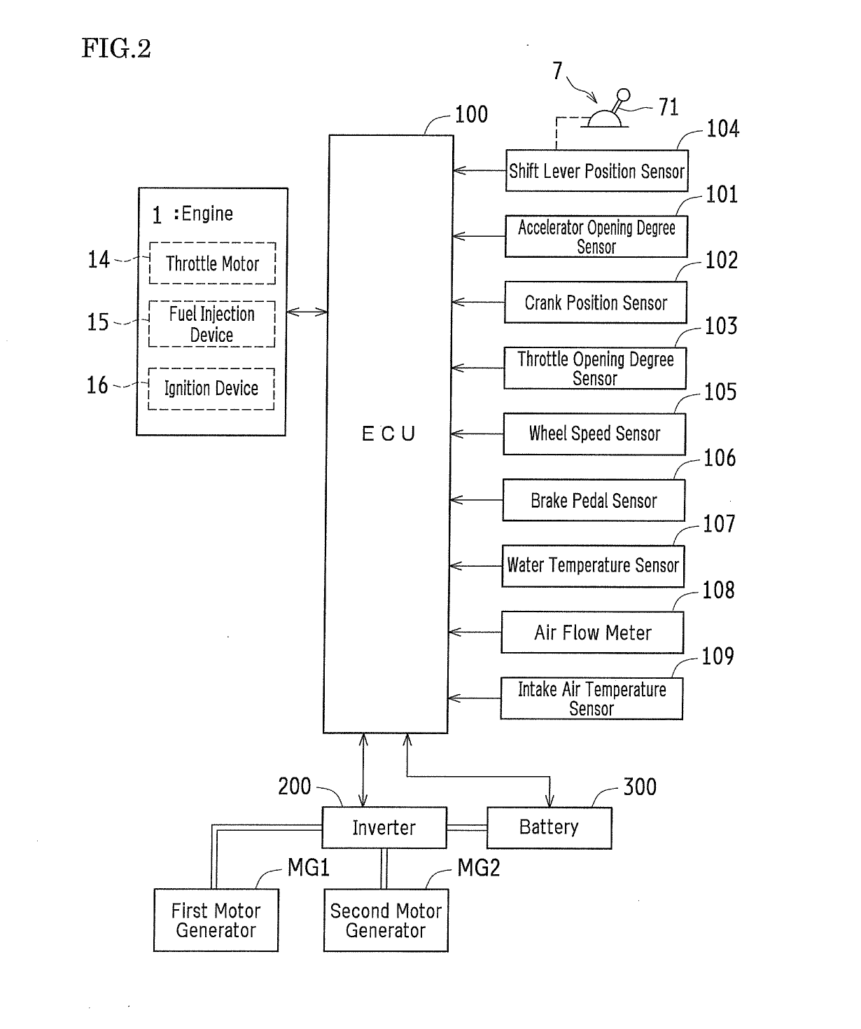

As illustrated in FIG. 2, the first motor generator MG1 and the second motor generator MG2 are connected to a battery (electric storage device) 300 via an inverter 200. The inverter 200 is controlled by the ECU 100. The motor generators MG1 and MG2 are each set up to operate either in regenerative mode or in travel (assist) mode through the control of the inverter 200. The electric power recovered in regenerative mode is stored in the battery 300 via the inverter 200. The electric power that drives the motor generators MG1 and MG2 is supplied from the battery 300 via the inverter 200.

### Power Division Mechanism

The power division mechanism 3, as illustrated in FIG. 1, is a planetary gear mechanism including a sun gear Sf, pinion gears Pf, a ring gear Rf, and a planetary carrier Cf. The sun gear Sf is an external gear that self-rotates at the center of gear elements. The pinion gears Pf are external gears that orbit around and in mesh with the sun gear Sf while self-rotating. The ring gear Rf is formed annularly so as to mesh with the pinion gears Pf. The planetary carrier Cf supports the pinion gears Pf and self-rotates as the pinion gears Pf orbit. The planetary carrier Cf is coupled to the input shaft 21 for the engine 1 so that the planetary carrier Cf and the input shaft 21 can rotate integrally. The sun gear Sf is coupled to a motor shaft 41 linked to the rotor MG1R of the first motor generator MG1 so that the sun gear Sf and the motor shaft 41 can rotate integrally.

The ring gear Rf of the power division mechanism 3 in accordance with the present embodiment has teeth formed on its both inner and outer circumferential faces. The teeth on the inner circumferential face mesh with the pinion gears Pf. The teeth on the outer circumferential face mesh with a counter driven gear 52, which will be described later in detail.

### Gear Train

Next will be described the gear train 5 that transmits torque to the differential device 8.

A motor shaft 42 linked to the rotor MG2R of the second motor generator MG2 is provided with a counter drive gear 51 in such a manner that the motor shaft 42 and the counter drive gear 51 can rotate integrally. The ring gear Rf of the power division mechanism 3 and the counter drive gear 51 mesh with the counter driven gear 52. The counter driven gear 52 is disposed at an end of a countershaft 53 (left end in FIG. 1) in such a manner that the counter driven gear 52 and the countershaft 53 can rotate integrally. The countershaft 53 extends horizontally (parallel to the aforementioned axial lines (of the motor shafts 41 and 42)) in a space between the first motor generator MG1 and the second motor generator MG2. The counter driven gear 52 has more teeth (a greater diameter) than the ring gear Rf and the counter drive gear 51. The structure of the counter driven gear 52 is by no means limited to this example and may, as an alternative example, have the same structure as the counter drive gear 51.

At the other end (right end in FIG. 1) of the countershaft 53 is there provided a differential pinion gear 54 in such a manner that the countershaft 53 and the differential pinion gear 54 can rotate integrally. The differential pinion gear 54 meshes with a differential ring gear 81 of the differential device 8.

This structure of the gear train 5 causes the torque output of the power division mechanism 3 (the torque transmitted to the ring gear Rf) and the torque output of the second motor generator MG2 (the torque transmitted to the counter drive gear 51) to be added at the counter driven gear 52 and transmitted to the differential device 8 via the countershaft 53, the differential pinion gear 54, and the differential ring gear 81 (in HV travel, which will be described later in detail). The torque transmitted to the differential device 8 is further transmitted to the drive wheels 6 via the drive shafts 61, thereby producing travel driving force.

The input shaft 21, the motor shafts 41 and 42, the countershaft 53, and other shaft elements are supported by a transaxle case via bearings (not shown) in a freely rotatable manner.

### Power Transmission Path to Oil Pump

Next will be described a power transmission path to the oil pump 9, which is a feature of the present embodiment.

As illustrated in FIG. 1, the pinion gears Pf are composed of stepped pinion gears. Specifically, the pinion gears Pf each include a main pinion gear section Pf1 and a subpinion gear section Pf2. The main pinion gear sections Pf1 have a relatively large diameter and meshes with the sun gear Sf and the ring gear Rf. The subpinion gear sections Pf2 are disposed on the same shaft as the main pinion gear sections Pf1 so that the subpinion gear sections Pf2 and the main pinion gear sections Pf1 can rotate integrally. The subpinion gear sections Pf2 have a smaller diameter (fewer teeth) than the main pinion gear sections Pf1. In the present embodiment, the subpinion gear sections Pf2 are disposed on the same side of the main pinion gear sections Pf1 as is the engine 1 (in the left side of FIG. 1).

The oil pump 9 is disposed between the damper 2 and the power division mechanism 3. The oil pump 9 has its drive shaft 91 coupled to a ring gear (pump-driving ring gear) R2 that is an internal gear.

The ring gear R2, coupled to the drive shaft 91 of the oil pump 9, meshes with the subpinion gear sections Pf2. In other words, the teeth on the inner circumferential face (internal teeth) of the ring gear R2 mesh with the teeth on the outer circumferential faces (external teeth) of the subpinion gear sections Pf2 to enable power transmission.

Hence, the ring gear R2 rotates with rotation (self-rotation) of the pinion gears Pf or rotation of the planetary carrier Cf (orbiting of the pinion gears Pf). That in turn rotates the drive shaft 91 of the oil pump 9, thereby driving the oil pump 9. Details of the driving state of the oil pump 9 will be described later.

The oil pump 9 may be a trochoid pump or a gear pump. As the oil pump 9 is driven, engine oil is drawn from a sump (oil pan; not shown), ejected from the oil pump 9, and purified through an oil filter (not shown). Thereafter, the engine oil is passed through an oil supply path (main gallery, etc.) and supplied to individual members inside the engine and the hybrid system that need lubrication (e.g., the gears of the power division mechanism 3) or cooling (e.g., the motor generator cooling pipe). The engine oil thus lubricates the members that need lubrication and cools down those that need cooling before flowing back into the sump (oil pan).

### ECU

The ECU 100 is an electronic control device that implements various control processes including control over the operation of the engine 1 and collective control over the engine 1 and the motor generators MG1 and MG2. The ECU 100 includes, for example, a CPU (central processing unit), a ROM (read only memory), a RAM (random access memory), and a backup RAM.

As illustrated in FIG. 2, the ECU 100 is connected to, for example, an accelerator opening degree sensor 101, a crank position sensor 102, a throttle opening degree sensor 103, a shift lever position sensor 104, a wheel speed sensor 105, a brake pedal sensor 106, a water temperature sensor 107, an air flow meter 108, and an intake air temperature sensor 109 so that the ECU 100 can receive signals from these sensors. The accelerator opening degree sensor 101 detects an accelerator opening degree Acc, i.e., the amount of depression of the accelerator pedal. The crank position sensor 102 transmits a pulse signal every time the crankshaft 10 rotates a predetermined angle. The shift lever position sensor 104 detects the manipulation position of a shift lever 71 of a shift-manipulating device 7 disposed in the passenger compartment. The wheel speed sensor 105 detects the rotational speed of the wheels 6. The brake pedal sensor 106 detects force applied on the brake pedal (brake pedal force). The water temperature sensor 107 detects the temperature of engine-cooling water. The air flow meter 108 detects the amount of intake air. The intake air temperature sensor 109 detects the temperature of intake air.

The ECU 100 is also connected to a throttle motor 14, a fuel injection device (injector) 15, and an ignition device 16. The throttle motor 14 drives the throttle valve 13 of the engine 1 to open/close the throttle valve 13.

The ECU 100 implements various control processes over the engine 1, including throttle opening degree control (intake air amount control), fuel injection amount control, and ignition period control for the engine 1, based on output signals of the various sensors listed above.

To manage the battery 300, the ECU 100 computes the charging state (SOC: State of Charge), the input limit Win, and the output limit Wout of the battery 300 based on, for example, the integrated value of the charging/discharging current detected by a current sensor and the battery temperature detected by a battery temperature sensor.

The inverter 200 converts a DC output current of the battery 300 to an AC current that drives the motor generators MG1 and MG2 according to, for example, instruction signals from the ECU 100 (e.g., an instructed torque value for the first motor generator MG1 and an instructed torque value for the second motor generator MG2). The inverter 200 also converts an AC current generated by the first motor generator MG1 as it is driven by the output power of the engine 1 and an AC current generated by the second motor generator MG2 as it is driven by regenerative braking into a DC current to charge the battery 300. In addition, the inverter 200 supplies an AC current generated by the first motor generator MG1 as the power that drives the second motor generator MG2 in accordance with traveling state.

### Power Flow in Hybrid System

In the hybrid vehicle HV arranged as above, the torque that should be output to the drive wheels 6 (required torque) is calculated based on the vehicle speed V and the accelerator opening degree Acc which corresponds to the amount of depression of the accelerator pedal effected by the driver. The operation of the engine 1 and the motor generators MG1 and MG2 is controlled so that the hybrid vehicle HV travels by required driving force that corresponds to the required torque.

Specifically, the operation of the engine 1 and the motor generators MG1 and MG2 is controlled so that the required torque can be obtained by using only the second motor generator MG2 to reduce fuel consumption when the hybrid vehicle HV is operating in an operating region where the required torque (determined from, for example, the accelerator opening degree Acc detected by the accelerator opening degree sensor 101 and the rotational speed of the engine 1 calculated based on output signals from the crank position sensor 102) is relatively low. In contrast, when the hybrid vehicle HV is operating in an operating region where the required torque is relatively high, the second motor generator MG2 is used, and the engine 1 is also driven, in order to obtain the required torque from the power outputs of these driving force sources (travel driving force sources).

More specifically, when the vehicle is accelerating from standstill or traveling at low speed with the engine 1 having low operating efficiency, the vehicle is controlled to travel only by the second motor generator MG2 (hereinafter, “EV travel” or “electric motor travel”). EV travel is implemented also when the driver has selected EV travel mode using a travel mode selection switch disposed inside the passenger compartment.

In contrast, in ordinary travel (hereinafter, “HV travel” or “engine travel”), the power output of the engine 1 is, for example, divided between two paths by the power division mechanism 3 so that one of the divided power outputs (the divided power output for the ring gear Rf) can drive the drive wheels 6 directly (i.e., by transmitted torque directly to the drive wheels 6) and that the other divided power output (the divided power for the sun gear Sf) can drive the first motor generator MG1 for power generation. The second motor generator MG2 is hence driven by the electric power generated by driving the first motor generator MG1, to assist the driving of the drive wheels 6 (via an electric path).

As detailed above, the power division mechanism 3 serves as a differential mechanism. This differential action enables continuously variable electric transmission where the gear ratio is electrically altered, by mechanically transmitting the major portion of the power output of the engine 1 to the drive wheels 6 and electrically transmitting the remaining portion of the power output of the engine 1 via the electric path that starts at the first motor generator MG1 and ends at the second motor generator MG2. Accordingly, the rotational speed and torque of the engine 1 can be changed independently of the rotational speed and torque of the drive wheels 6. The arrangement hence delivers the required driving force to the drive wheels 6 and still enables the engine 1 to operate under operating conditions that optimize fuel consumption.

When the vehicle is traveling at high speed, the second motor generator MG2 is powered also by the battery 300 to increase the output of the second motor generator MG2, which in turn increases the driving force of the drive wheels 6 (driving force assist mode; travel mode).

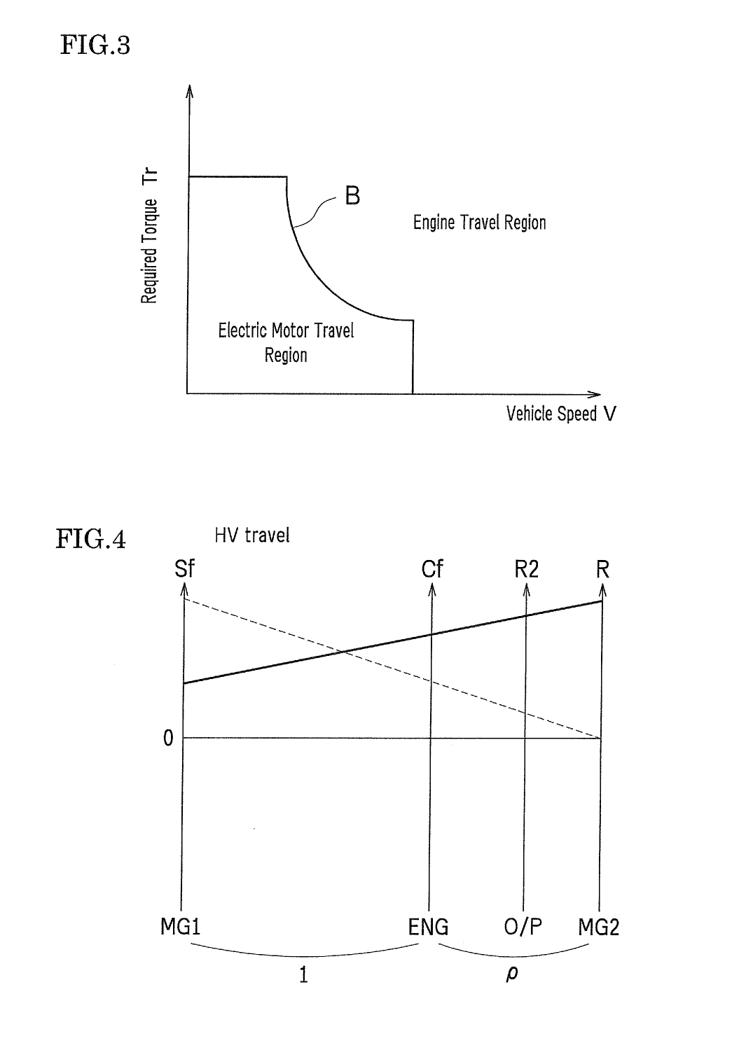

Switching between the electric motor travel (EV travel) and the engine travel (HV travel) is carried out according to the driving force source map shown in FIG. 3. The driving force source map is intended to enable selection between travel modes (electric motor travel and engine travel) based on the vehicle speed V and the required torque Tr. The region in the driving force source map in which the vehicle speed or required torque is lower than on solid line B is designated as the electric motor travel region; in this region, the vehicle travels by using only the second motor generator MG2 as the travel driving force source if the amount of charge SOC of the battery 300 is greater than or equal to a predetermined value. Meanwhile, the region in which the vehicle speed or required torque is higher than on solid line B is designated as the engine travel region; in this region, the vehicle travels by using the engine 1 as a travel driving force source (when necessary, additionally by using the second motor generator MG2 as another travel driving force source).

When the vehicle is decelerating, the second motor generator MG2 operates as an electric power generator for regenerative power generation and stores the recovered electric power in the battery 300. If the amount of charge (remaining charge; SOC) of the battery 300 has decreased to such a level that the battery 300 strongly needs to be charged, the power generation by the first motor generator MG1 is increased by increasing the output of the engine 1, so that the amount of charge of the battery 300 is increased (P charging). When the vehicle is traveling at low speed, the engine 1 may likewise be controlled to increase its output as necessary, for example, when the battery 300 needs be charged as mentioned above, an air conditioner or other accessory needs to be driven, or the cooling water for the engine 1 needs to be warmed up to a predetermined temperature.

In the hybrid vehicle HV in accordance with the present embodiment, the engine 1 may be stopped to improve fuel economy according to the operating conditions of the hybrid vehicle HV and the state of the battery 300. After the engine 1 is stopped, the operating conditions of the hybrid vehicle HV and the state of the battery 300 are continuously monitored to restart the engine 1. In the hybrid vehicle HV, the engine 1 operates intermittently (the engine repeatedly stops and restarts) in this manner.

### Driving State of Oil Pump

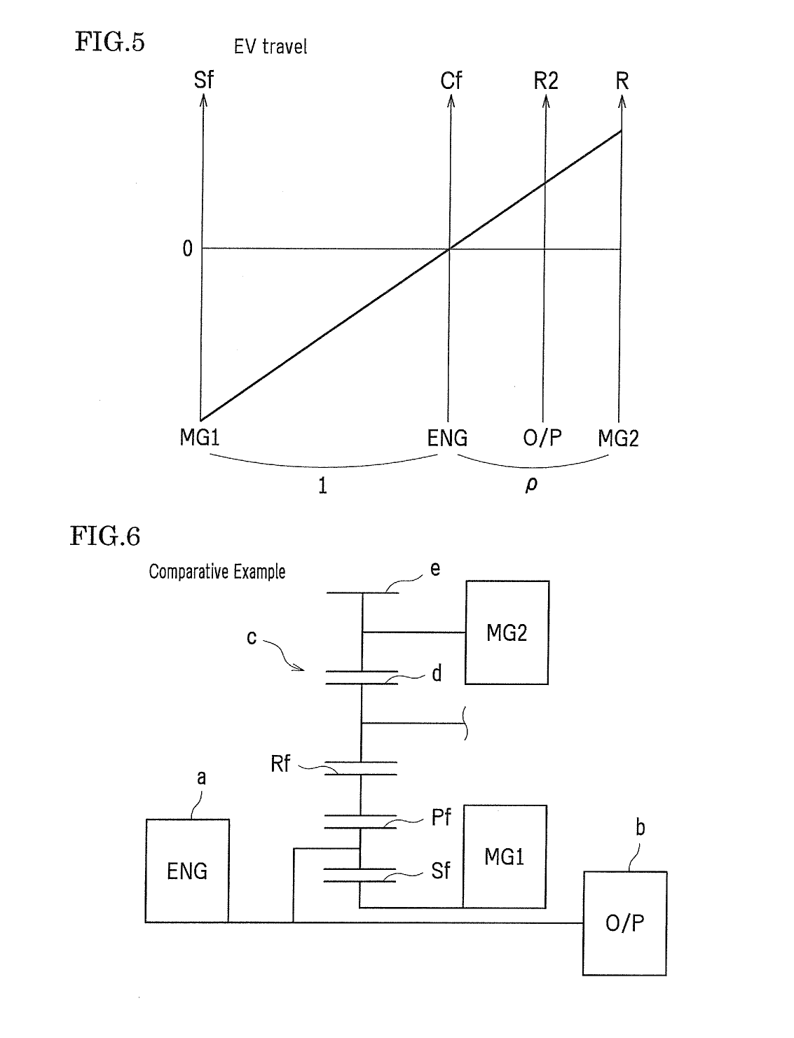

Next will be described the driving state of the oil pump 9 to which power is transmitted by a power transmission system arranged as detailed above. The description will discuss the driving state of the oil pump 9 in HV travel and EV travel in reference to the collinearity graph in FIGS. 4 and 5.

The vertical axes Sf, Cf, and R in FIGS. 4 and 5 represent the rotational speed of the sun gear Sf, the rotational speed of the planetary carrier Cf, and the rotational speed of the ring gear Rf respectively. The distances between these vertical axes Sf, Cf, and R are specified so that letting the distance between the vertical axis Sf and the vertical axis Cf equal to 1, the distance between the vertical axis Cf and the vertical axis R equals p (i.e., Gear Ratio ρ of Power Division Mechanism 3=Number of Teeth of Sun Gear Sf/Number of Teeth of Ring Gear Rf). The vertical axis R2 represents the rotational speed of the ring gear R2 coupled to the drive shaft 91 of the oil pump (O/P) 9. The upper half of this collinearity graph (above the zero rotational speed line) represents positive rotation, whereas the lower half (below the zero rotational speed line) represents negative rotation.

Driving State of Oil Pump in HV travel

FIG. 4 is a collinearity graph representing exemplary rotational speeds of various rotational elements of the power division mechanism 3 in HV travel.

In HV travel, the engine 1 is driven, transmitting a torque to the planetary carrier Cf. As the first motor generator MG1 applies to the sun gear Sf a counterforce torque that counteracts this torque input from the engine (ENG) 1 to the planetary carrier Cf, the ring gear (output element) Rf receives a torque whose magnitude is equal to the addition/subtraction of these torques. In this situation, the rotor MG1R of the first motor generator MG1 is rotated by the resultant torque, and the first motor generator MG1 operates as an electric power generator. If the rotational speed of the ring gear Rf (output rotational speed R) is constant, the rotational speed of the engine 1 can be continuously varied by changing the rotational speed of the first motor generator MG1 as mentioned above. In other words, the rotational speed of the engine 1 can be controlled, for example to optimize fuel economy, by controlling the first motor generator MG1.

The engine 1, running in HV travel, either rotates the planetary carrier Cf (causes the pinion gears Pf to orbit) or further causes the pinion gears Pf to self-rotate through this rotation of the planetary carrier Cf. The rotational force generated in this manner is transmitted to the ring gear R2 via the subpinion gear sections Pf2, thereby rotating the ring gear R2.

Specifically, when the rotational speed (rotational angular velocity) of the sun gear Sf is equal to the rotational speed (rotational angular velocity) of the ring gear Rf in HV travel, the pinion gears Pf orbit without self-rotating because the planetary carrier Cf is driven to rotate by the engine 1. The rotational force of this orbiting is transmitted to the ring gear R2 via the subpinion gear sections Pf2, thereby rotating the ring gear R2. In contrast, when there is a difference between the rotational speed of the sun gear Sf and the rotational speed of the ring gear Rf in HV travel, the pinion gears Pf self-rotate in accordance with the rotational speed difference. In other words, the pinion gears Pf orbit while self-rotating, and its rotational force is transmitted to the ring gear R2 via the subpinion gear sections Pf2, thereby rotating the ring gear R2.

This rotation of the ring gear R2 in either case rotates the drive shaft 91 of the oil pump 9, thereby driving the oil pump 9. The oil pump 9, driven in this manner, ejects the engine oil drawn from the sump (oil pan) to supply the engine oil to various members inside the engine and the hybrid system that need lubrication or cooling. Hence, the members that need lubrication are lubricated, and the members that need cooling are cooled down.

As described above, the oil pump 9 is being driven while the engine 1 is running. The state of the vehicle while the engine is running is by no means limited to HV travel and may also be P charging discussed above with the vehicle being stopped (the engine 1 is run because the amount of charge SOC of the battery 300 has decreased to or below such a predetermined level that the battery 300 needs to be charged). In this P charging, similarly to the HV travel described above, the engine 1, which is running, rotates the planetary carrier Cf and causes the pinion gears Pf to orbit while self-rotating. The ring gear R2 thus rotates. That in turn rotates the drive shaft 91 of the oil pump 9, thereby driving the oil pump 9. (See the rotational speeds of the rotational elements indicated by a broken line in the collinearity graph of FIG. 4).

### Driving State of Oil Pump in EV Travel

FIG. 5 is a collinearity graph representing exemplary rotational speeds of various rotational elements of the power division mechanism 3 in EV travel.

In EV travel, the engine 1 is stopped (the rotational speed of the planetary carrier Cf is “0”), and the second motor generator MG2 is controlled so as to deliver the power requested by the driver. In this situation, the first motor generator MG1 rotates in an opposite direction to keep the engine 1 being stopped. By driving the second motor generator MG2 with the engine 1 being stopped in this manner, EV travel is enabled with the engine 1 showing no drag resistance, while efficiently driving the second motor generator MG2.

In such EV travel, since the vehicle is traveling, the ring gear Rf of the power division mechanism 3 rotates. Being in mesh with the ring gear Rf, the pinion gears Pf self-rotate (since the planetary carrier Cf is stopped, the pinion gears Pf self-rotate without orbiting). These self-rotating pinion gears Pf transmit their rotational force to the ring gear R2 via the subpinion gear sections Pf2, thereby rotating the ring gear R2. The rotation of the ring gear R2 in turn rotates the drive shaft 91 of the oil pump 9, thereby driving the oil pump 9. The oil pump 9, driven in this manner, ejects the engine oil drawn from the sump (oil pan) for supply to various members inside the engine and the hybrid system that need lubrication or cooling. Hence, the members that need lubrication are lubricated, and the members that need cooling are cooled down.

As described above, with the power transmission system of a hybrid vehicle HV in accordance with the present embodiment, the oil pump 9 is driven no matter whether the vehicle is in HV travel, P charging, or EV travel so that engine oil can be supplied to members that need lubrication or cooling.

### Comparison with Comparative Examples

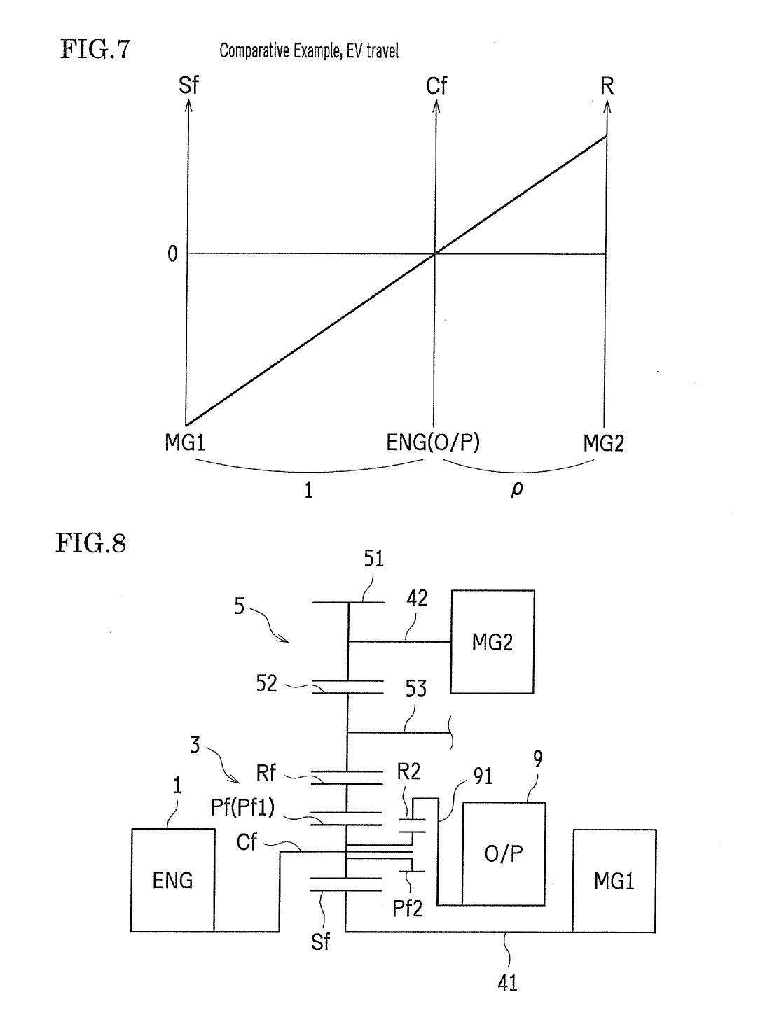

FIG. 6 represents an arrangement of a power transmission system in which an oil pump “b” is directly coupled to the output shaft of an engine “a” as a comparative example (FIG. 6 shows only an upper half of the power transmission system). FIG. 7 is a collinearity graph representing the rotational speeds of various rotational elements of a power division mechanism “c” in EV travel for a hybrid vehicle that includes the power transmission system shown in FIG. 6. Those gears of the power division mechanism “c” shown in FIG. 6 that are similar to those in the embodiment above are indicated by the same reference signs. In FIG. 6, reference sign “d” indicates a counter driven gear that is meshed with the ring gear Rf, and reference sign “e” indicates a counter drive gear that is linked to the second motor generator MG2 and meshed with the counter driven gear “d.”

In this comparative example, the oil pump “b” is directly coupled to the output shaft of the engine “a.” Therefore, in EV travel, as the engine “a” stops (see the rotational speed on the vertical axis Cf in the collinearity graph of FIG. 7), the oil pump (O/P) “b” also stops. Therefore, no engine oil is supplied to members that need lubrication or cooling. Those members are consequently not lubricated or cooled down.

According to the present embodiment, the drive shaft 91 of the oil pump 9 receives the rotational force of the pinion gears Pf (rotational force of the subpinion gear sections Pf2) to drive the oil pump 9 as described above. The oil pump 9 is hence driven even in EV travel and is capable of supplying engine oil to the members that need lubrication or cooling.

As described in the foregoing, according to the present embodiment, the pinion gears Pf are composed of stepped pinion gears, and the ring gear R2 coupled to the drive shaft 91 of the oil pump 9 is meshed with the subpinion gear sections Pf2 of the pinion gears Pf. This arrangement enables the oil pump 9 to be driven no matter whether the vehicle is in HV travel, P charging, or EV travel. That eliminates the need for an electric oil pump in the vehicle, reduces the space that accommodates the oil pump 9, and facilitates installation of the oil pump 9 in the engine compartment. As a result, vehicle design is not limited by the need to set aside a space to accommodate the oil pump. Cost may also be lowered. In addition, there is no need for the arrangement of conventional art (Patent Document 3) where two power transmission paths to the input shaft of the oil pump are provided with individual one-way clutches. Hence, an arrangement is realized that is capable of driving the oil pump 9 in EV travel without adding to the physical dimensions of the power transmission system.

Additionally, as described above, the oil pump 9 is driven, thereby sufficiently lubricating the gears of the power division mechanism 3, regardless of the state of the hybrid vehicle HV. For this reason, the tolerable rotational speeds of the gears (especially, those of the pinion gears Pf) can be increased, which contributes to increased performance of the hybrid system. Furthermore, since the members that need lubrication and cooling are sufficiently lubricated and cooled down in EV travel, EV travel can be continued over an extended period of time and an extended distance.

Furthermore, since the subpinion gear sections Pf2 have a smaller diameter than the main pinion gear sections Pf1 in the present embodiment, the subpinion gear sections Pf2 and the ring gear R2 meshed with the subpinion gear sections Pf2 can be accommodated in a reduced space, which facilitates installation of the subpinion gear sections Pf2 and the ring gear R2 in the engine compartment.

### Variation Example 1

Next, variation example 1 will be described. The present variation example differs from the embodiment above in the location of the oil pump 9. The description below will focus on differences from the embodiment above.

FIG. 8 represents an arrangement of a power transmission system for a hybrid vehicle HV in accordance with the present variation example (FIG. 8 shows only an upper half of the power transmission system).

As illustrated in FIG. 8, in a power transmission system for a hybrid vehicle HV in accordance with the present variation example, an oil pump 9 is disposed between a power division mechanism 3 and a first motor generator MG1. To allow for this arrangement, the subpinion gear sections Pf2 of pinion gears Pf composed of stepped pinion gears are disposed on the same side of the main pinion gear sections Pf1 as is the first motor generator MG1 (on the opposite side from the engine; in the right side of FIG. 8). The present variation example is otherwise arranged and functions in the same manner as the embodiment above. Structural members in FIG. 8 that are identical to those in the power transmission system of the embodiment above are indicated by the same reference signs.

The present variation example achieves similar effects to the embodiment above. Specifically, a power transmission system is realized that is capable of driving the oil pump 9 even in EV travel without adding to the physical dimensions of the power transmission system. Furthermore, the present variation example allows the oil pump 9 to be disposed away from the engine 1 (on the right side in the figure, away from engine 1 when compared to the embodiment above). Therefore, the oil pump 9 will unlikely receive thermal damage, for example, under heat radiation from the engine 1, which enables extended life for the oil pump 9.

### Variation Example 2

Next, variation example 2 will be described. The present variation example differs from the embodiment above in the arrangement of the power transmission system. The description below will focus on differences from the embodiment above.

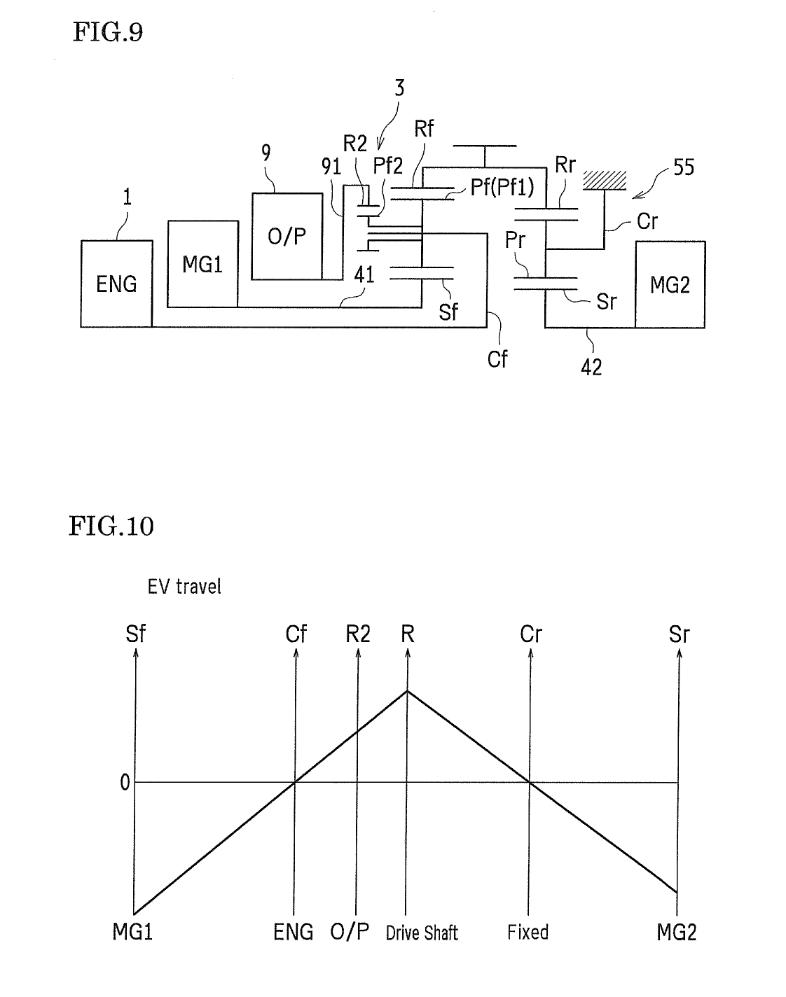

FIG. 9 represents an arrangement of a power transmission system for a hybrid vehicle HV in accordance with the present variation example (FIG. 9, like some previous figures, shows only an upper half of the power transmission system).

As illustrated in FIG. 9, in a power transmission system for a hybrid vehicle HV in accordance with the present variation example, a second motor generator MG2 transmits its power to a ring gear Rf via a reduction mechanism 55.

The reduction mechanism 55 is composed of a planetary gear mechanism including a sun gear Sr, pinion gears Pr, and a ring gear Rr. The sun gear Sr is an external gear that self-rotates at the center of gear elements. The pinion gears Pr are external gears that are supported by a planetary carrier (transaxle case) Cr in a freely rotatable manner and that self-rotate in mesh with the sun gear Sr. The ring gear Rr is an internal gear formed annularly so as to mesh with the pinion gears Pr. The ring gear Rr of the reduction mechanism 55 and the ring gear Rf of the power division mechanism 3 are integrated. The sun gear Sr of the reduction mechanism 55 is coupled to a motor shaft 42 that is linked to the second motor generator MG2, so as to rotate integrally.

The reduction mechanism 55 decelerates the output power of the second motor generator MG2 at a suitable deceleration ratio. This decelerated power is added to the output power of the power division mechanism 3. The resultant power is transmitted to a differential device (not shown).

The pinion gears Pf of the power division mechanism 3 in the present variation example are also composed of stepped pinion gears. The subpinion gear sections Pf2 are meshed with the ring gear (internal gear) R2 coupled to the drive shaft 91 of the oil pump 9. Accordingly, similarly to the embodiment above and variation example 1, a power transmission system is realized that is capable of driving the oil pump 9 even in EV travel without adding to the physical dimensions of the power transmission system.

The present variation example is otherwise arranged and functions in the same manner as the embodiment above. Structural members in FIG. 9 that are identical to those in the power transmission system of the embodiment above are indicated by the same reference signs.

FIG. 10 is a collinearity graph representing the rotational speeds of various rotational elements of the power division mechanism 3 and the reduction mechanism 55 in EV travel for a hybrid vehicle HV in accordance with the present variation example.

The vertical axes Sf, Cf, and R in FIG. 10 represent the rotational speed of the sun gear Sf, the rotational speed of the planetary carrier Cf, and the rotational speed of the ring gear Rf, respectively, in the power division mechanism 3. The vertical axes Cr and Sr represent the rotational speed of the planetary carrier Cr and the rotational speed of the sun gear Sr, respectively, in the reduction mechanism 55. The vertical axis R2 in FIG. 10 represents the rotational speed of the ring gear R2 coupled to the drive shaft 91 of the oil pump 9.

This collinearity graph clearly shows that the power transmission system for the hybrid vehicle in accordance with the present variation example enables the oil pump 9 to be driven even in EV travel.

### Variation Example 3

Next, variation example 3 will be described. The present variation example differs from variation example 2 in the location of the oil pump 9. The description below will focus on differences from variation example 2.

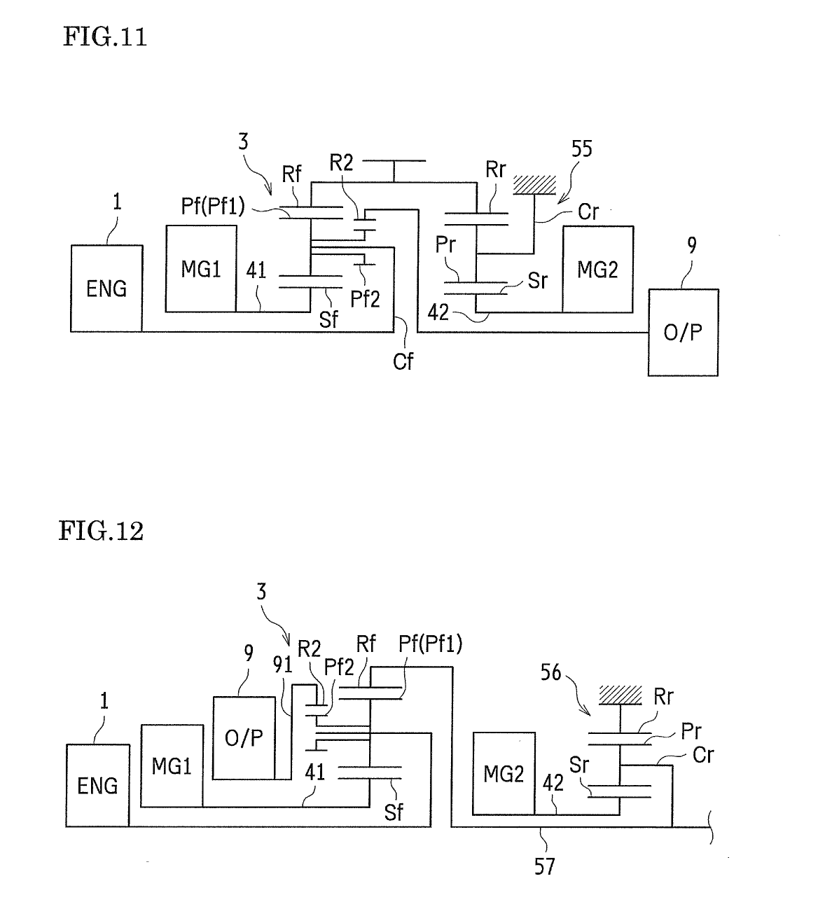

FIG. 11 represents an arrangement of a power transmission system for a hybrid vehicle HV in accordance with the present variation example (FIG. 11, like some previous figures, shows only an upper half of the power transmission system).

As illustrated in FIG. 11, in a power transmission system for a hybrid vehicle HV in accordance with the present variation example, an oil pump 9 is disposed on the opposite side of the second motor generator MG2 from the engine. To allow for this arrangement, the subpinion gear sections Pf2 of pinion gears Pf composed of stepped pinion gears are disposed on the same side of the main pinion gear sections Pf1 in the power division mechanism 3 as is the second motor generator MG2 (on the opposite side from the engine; toward the right-hand side of FIG. 11). The present variation example is otherwise arranged and functions in the same manner as variation example 2. Structural members in FIG. 11 that are identical to those in the power transmission system of variation example 2 are indicated by the same reference signs.

The present variation example achieves similar effects to the embodiment and variation examples above. Specifically, a power transmission system is realized that is capable of driving the oil pump 9 even in EV travel without adding to the physical dimensions of the power transmission system. Furthermore, the present variation example allows the oil pump 9 to be disposed further away from the engine 1 when compared to variation examples 1 and 2. Therefore, the oil pump 9 will unlikely receive thermal damage, for example, under heat radiation from the engine 1, which enables extended life for the oil pump 9.

### Variation Example 4

Next, variation example 4 will be described. The present variation example is an application of the present invention to an FR (front engine, rear wheel drive) hybrid vehicle.

FIG. 12 represents an arrangement of a power transmission system for a hybrid vehicle HV in accordance with the present variation example (FIG. 12, like some previous figures, shows only an upper half of the power transmission system).

As illustrated in FIG. 12, in a power transmission system for a hybrid vehicle HV in accordance with the present variation example, a second motor generator MG2 is connected via a reduction mechanism 56 composed of a planetary gear mechanism to an output shaft 57 linked to a ring gear Rf of a power division mechanism 3.

Specifically, the reduction mechanism 56 is composed of a planetary gear mechanism including a sun gear Sr, pinion gears Pr, and a ring gear Rr. The sun gear Sr is an external gear that self-rotates at center of gear elements. The pinion gears Pr are external gears that are supported by a carrier Cr in a freely rotatable manner and that self-rotate in mesh with the sun gear Sr. The ring gear Rr (fixed to a transaxle case) is an internal gear formed annularly so as to mesh with the pinion gears Pr. The sun gear Sr is coupled to a motor shaft 42 that is linked to the second motor generator MG2, so as to rotate integrally. The carrier Cr is coupled to the output shaft 57 so as to rotate integrally.

The reduction mechanism 56 decelerates the output power of the second motor generator MG2 at a suitable deceleration ratio. This decelerated power is transmitted from the carrier Cr to the output shaft 57.

The pinion gears Pf of the power division mechanism 3 in the present variation example are also composed of stepped pinion gears. The subpinion gear sections Pf2 are meshed with the ring gear (internal gear) R2 coupled to the drive shaft 91 of the oil pump 9. Accordingly, similarly to the embodiment and variation examples above, a power transmission system is realized that is capable of driving the oil pump 9 even in EV travel without adding to the physical dimensions of the power transmission system.

The present variation example is otherwise arranged and functions in the same manner as the embodiment and variation examples above. Structural members in FIG. 12 that are identical to those in one of the power transmission systems of the embodiment and variation examples above are indicated by the same reference signs.

The oil pump 9 may also be disposed between the power division mechanism 3 and the second motor generator MG2 when the present invention is applied to an FR hybrid vehicle as in this variation example. Specifically, the subpinion gear sections Pf2 of the pinion gears Pf composed of stepped pinion gears are disposed on the same side of the main pinion gear sections Pf1 as is the second motor generator MG2 (on the right side of FIG. 12).

### Other Embodiments

The embodiment and variation examples above described the present invention being applied to an FF hybrid vehicle HV and an FR hybrid vehicle HV. Applications of the present invention are not limited to these examples; the present invention may be applied to a four wheel drive hybrid vehicle.

In addition, the embodiment and variation examples above described the present invention being applied, as examples, to hybrid vehicles HV provided with two electric motors (the first motor generator MG1 and the second motor generator MG2). The present invention is however applicable to hybrid vehicles provided with one, three, or more than three electric motors so long as the hybrid vehicles have a planetary gear mechanism in their power transmission systems.

In addition, in the embodiment and variation examples above, the pinion gears Pf that transmit power to the oil pump 9 are composed of stepped pinion gears. The present invention is by no means limited to this arrangement; alternatively, the pinion gears Pf may be composed of a gear in which a gear section meshed with a sun gear Sf and the ring gear Rf of the power division mechanism 3 is contiguous to a gear section meshed with the ring gear R2 coupled to the drive shaft 91 of the oil pump 9 (a gear with an extended axial length and successive teeth). When this is actually the case, the gear section meshed with the sun gear Sf and the ring gear Rf (an equivalent of the main pinion gear sections Pf1) have the same number of teeth as the gear section meshed with the ring gear R2 (an equivalent of the subpinion gear sections Pf2).

Furthermore, in the embodiment and variation examples above, power is transmitted from the pinion gears Pf to the drive shaft 91 of the oil pump 9 by means of meshing of gears. The present invention is by no means limited to this arrangement; alternatively, power may be transmitted by chains, a belt, or any other suitable means.

### INDUSTRIAL APPLICABILITY

The present invention is applicable to a hybrid vehicle that includes a planetary gear mechanism in its power transmission system that drives an oil pump in EV travel.

### REFERENCE SIGNS LIST

1 Engine (Internal Combustion Engine)
3 Power Division Mechanism (Planetary Gear Mechanism)
6 Front Wheels (Drive Wheels)
9 Oil Pump
91 Input Shaft (Drive Shaft)
HV Hybrid Vehicle
Sf Sun Gear
Rf Ring Gear
Cf Planetary Carrier
Pf Pinion Gears
R2 Ring Gear (Pump-driving Ring Gear)
Pf1 Main Pinion Gear Sections
Pf2 Subpinion Gear Sections
MG1 First Motor Generator (First Electric Motor)
MG2 Second Motor Generator (Second Electric Motor)

1. A hybrid vehicle, comprising a power transmission system including a planetary gear mechanism containing: a planetary carrier coupled to an output shaft of an internal combustion engine; a sun gear coupled to an electric motor; and a ring gear coupled to a drive wheel,
wherein pinion gears that are supported by the planetary carrier of the planetary gear mechanism in a freely rotatable manner are coupled to a drive shaft of an oil pump to enable power transmission.

2. The hybrid vehicle as set forth in claim 1, wherein
the pinion gears include stepped pinion gears each including a main pinion gear section and a subpinion gear section that are formed so as to rotate integrally,
the main pinion gear sections are meshed with the sun gear and the ring gear of the planetary gear mechanism,
the subpinion gear sections are meshed with a pump-driving ring gear coupled to the drive shaft of the oil pump.

3. The hybrid vehicle as set forth in claim 2, wherein the subpinion gear sections have a smaller diameter than the main pinion gear sections.

4. The hybrid vehicle as set forth in claim 2, wherein the subpinion gear sections of the pinion gears are disposed on the same side of the main pinion gear sections as is the internal combustion engine.

5. The hybrid vehicle as set forth in claim 2, wherein the subpinion gear sections of the pinion gears are disposed on the opposite side of the main pinion gear sections from the internal combustion engine.

6. The hybrid vehicle as set forth in claim 1, wherein
there is provided a second electric motor capable of power transmission to and from the ring gear of the planetary gear mechanism via a gear train, and
the second electric motor transmits power thereof to the drive wheel via the gear train while the vehicle is traveling with the internal combustion engine being stopped and the planetary carrier not rotating.
